(19) United States
(12) Patent Application Publication
(10) Pub. No.: US 2013/0309545 A1
(43) Pub. Date: Nov. 21, 2013

(54) DEVICE FOR PRESSING A COOLER AGAINST A BATTERY

(71) Applicants: Nikolaus Daubitzer, Allershausen (DE); Martin Engelhardt, Ditzingen (DE); Thomas Heckenberger, Leinfelden-Echterdingen (DE); Thomas Himmer, Reichenbach (DE); Lars Ludwig, Esslingen (DE); Florian Moldovan, Stuttgart (DE); Michael Moser, Rainau (DE); Heiko Neff, Stuttgart (DE); Rudolf Riedel, Pforzheim (DE); Caroline Schmid, Stuttgart (DE); Holger Schroth, Maulbronn (DE); Martin Steinbach, Waiblingen (DE)

(72) Inventors: Nikolaus Daubitzer, Allershausen (DE); Martin Engelhardt, Ditzingen (DE); Thomas Heckenberger, Leinfelden-Echterdingen (DE); Thomas Himmer, Reichenbach (DE); Lars Ludwig, Esslingen (DE); Florian Moldovan, Stuttgart (DE); Michael Moser, Rainau (DE); Heiko Neff, Stuttgart (DE); Rudolf Riedel, Pforzheim (DE); Caroline Schmid, Stuttgart (DE); Holger Schroth, Maulbronn (DE); Martin Steinbach, Waiblingen (DE)

(73) Assignee: BEHR GMBH & CO. KG, Stuttgart (DE)

(21) Appl. No.: 13/982,567

(22) PCT Filed: Feb. 2, 2012
(86) PCT No.: PCT/EP12/51804

§ 371 Date: Jul. 30, 2013

(30) Foreign Application Priority Data
Feb. 2, 2011 (DE) 10-2011-003-538.9

(51) Int. Cl. H01M 10/50

(52) U.S. Cl. CPC H01M 10/5004
USPC 429/120; 429/121; 29/623.1

(57) ABSTRACT

The invention relates to a device for pressing a cooler against a battery, said cooler having at least one cooling surface for absorbing or dissipating thermal energy, and the battery having at least one contact surface for the cooling surface of the cooler to rest on. The device comprises a pressure part having at least one spring-elastic pressure element for transmitting a contact pressure onto a section of the surface of the cooler facing away from the battery. The device further comprises at least one suspension unit for suspending the pressure part on the battery, said suspension unit being designed such as to generate a suspension force which is counter to the contact force when the cooler is arranged on the battery and the suspension unit is suspended on the battery.

The present invention relates to a device for pressing a cooler against a battery, to an energy accumulator device, and to a method for producing an energy accumulator device according to the main claims.

In order to guarantee the longevity of a battery during charging, discharging or storage and to ensure the optimum efficiency thereof during operation, the battery has to be kept within a defined temperature range such that the battery becomes neither too hot nor too cold. For this purpose, the battery or a stack is equipped with a cooler or a heater which brings about and maintains the optimum battery temperature. However, the cooler deploys the maximum effectiveness thereof only upon optimum connection thereof to the battery.

It is the object of the present invention to provide an improved device for pressing a cooler against a battery, an improved energy accumulator device and an improved method for producing an energy accumulator device.

This object is achieved by a device for pressing a cooler against a battery, by an energy accumulator device, and by a method for producing an energy accumulator device according to the main claims.

The present invention is based on the finding that clamping straps having different clamping concepts can be used for connecting a battery cooler to a battery. Furthermore, use can be made of interface materials which lower the heat transfer resistance between cooler and battery and/or increase the usable cooling surface, in order to achieve an optimum connection. An optimum connection in terms of heat technology of a cooling plate to the battery can be achieved by a uniform distribution of a contact pressure. For this purpose, use can be made of plastically preshaped or precurved means in order to be able to apply an extensively distributed force to the cooler.

By using clamping straps, as presented here, a reduction in a heat transmission resistance between an energy accumulator module and a temperature-control unit can advantageously be achieved. Complicated working steps, such as soldering or welding, and also the use of bonding can be superfluous as a result. A reduction in an outlay on work can result in lower production costs.

The present invention provides a device for pressing a cooler against a battery, wherein the cooler has at least one cooling surface for absorbing or dissipating thermal energy, and the battery has at least one contact surface for the cooling surface of the cooler to rest on, wherein the device has the following features:

a pressure part with at least one spring-elastic pressure element for transmitting a press-on force to a subregion of a surface of the cooler that faces away from the battery; and a suspension unit for suspending the pressure part on the battery, wherein the suspension unit is designed in order to produce a suspension force directed counter to the press-on force when the cooler is arranged on the battery and the suspension unit is suspended on the battery.

A cooler is understood as meaning a device which can absorb and conduct away, or supply and dissipate thermal energy. For example, the cooler can be a heat exchanger. The cooler can have at least one surface in order to be arranged on a battery. For example, the surface can be a cooling surface. The battery can be understood as meaning a device which, by means of an electrochemical reaction, can convert electrical energy into chemical energy and can store the latter and, in the reverse electrochemical reaction, can convert stored chemical energy into electrical energy and can provide the latter to at least two electric contacts. For example, the battery can be an electrochemical energy accumulator module or a storage battery. The battery can have a single-part housing or a multi-part housing which can have at least one surface for the arrangement of a cooler. For example, the surface can have a contact surface. The housing can have a reinforcing element in order to increase the stability of the housing. A reinforcing element can be, for example, a cover plate. A pressure part can be understood as meaning a means which can directly or indirectly exert a force on the cooler perpendicularly to the contact surface of the battery. For example, the pressure part can be a clamping strap made of a spring-elastic material in wire or belt form. A plurality of pressure parts can likewise be combined. A pressure element can be a spring-elastic formation of the pressure part, the formation forming a defined pressure point which can enter into direct contact with the cooler and can transmit the press-on force to the cooler. A suspension unit can be understood as meaning at least one means which adjoins the pressure part, for example integrally, and has at least one formation which is designed in order to enter into a frictional and/or form-fitting connection with the battery. The suspension force can be produced here, for example, by elastic deformation of a hook. For example, a projection can bring about a form-fitting connection. The suspension unit can be, for example, a clamping strap made of a spring-elastic material in wire or belt form. A plurality of suspension units can likewise be combined.

According to a further embodiment of the present invention, the suspension unit can have at least one elastically stretchable section in order to produce the suspension force when the section is stretched. An elastically stretchable section can be a precurved part of the suspension unit, which part is deformed counter to the precurvature during the suspension and, by means of a resulting restoring force, can produce the suspension force. Manufacturing tolerances in the battery and the cooler can thereby be compensated for. In addition, each suspended suspension unit brings about the suspension force for the associated pressure part.

Furthermore, the pressure part can also have a plurality of spring-elastic pressure elements which can have different heights in order to distribute the press-on force uniformly to a plurality of subregions of the cooler. By means of different heights, the pressure elements, which are embodied as springs, can transmit differently sized portions of the press-on force. For example, a lower portion in regions of high press-on force than in regions with a low press-on force. Different heights can also compensate for a deformation of the pressure part under the press-on force such that a resulting press-on surface can be flat in the assembled state.

According to a further embodiment of the present invention, the pressure part can have a spring-elastic basic body which has a precurvature when the suspension unit is not suspended. A precurvature can be understood as meaning a plastic deformation during production. The precurvature can bring about at least part of the press-on force in the form of elastic deformation during installation. As a result, the press-on force can be distributed uniformly over a contact surface of the pressure part with the cooler.

The device can comprise a plurality of pressure parts which are connected at least to one spacer and are arranged next to one another. A spacer can be understood as meaning a connecting element. For example, the spacer can have means for receiving at least two pressure parts in order to arrange the latter at a predetermined distance next to one another. The spacer can also be formed over the full surface. The pressure part can then mark a region of the spacer that has the pressure elements. By means of a spacer, the press-on force can be transmitted to the cooler uniformly by a plurality of pressure parts.

In one embodiment, the suspension unit can be designed in order to be suspended on a surface of the battery that is opposite the contact surface of the battery. A surface of the battery that is opposite the contact surface of the battery can be a cover surface. For example, the surface can have contact connection means for the battery. As a result, the cooler can be pressed against the battery by means of one or more simple components, and further components can be dispensed with.

Furthermore, the suspension unit can be designed in order to be suspended on a suspension unit arranged in the region of the contact surface of the battery. The battery can have a latching unit in order to latch the suspension unit. For example, a latching unit can be an opening with an integrated undercut to which a latching lug of the suspension unit can latch.

The present invention furthermore provides an energy accumulator device with the following features:

a cooler with at least one cooling surface for absorbing or dissipating thermal energy;

a battery with at least one contact surface for the cooling surface of the cooler to rest on, wherein the cooler is arranged on the battery; and

a device for pressing a cooler onto a battery according to one embodiment of the invention, wherein the suspension unit is suspended on the battery and produces the suspension force, which is directed counter to the press-on force, and the pressure part transmits the press-on force to a subregion of a surface of the cooler that faces away from the battery, with the at least one pressure part.

In one embodiment of the energy accumulator device, an intermediate material can be arranged between the cooler and the battery, said intermediate material compensating for unevennesses in the heat transmission surface and/or the contact surface via a plastic and, additionally or alternatively, elastic deformation. An intermediate material can be understood as meaning an interface material, i.e. a means for lowering a heat transmission resistance. For example, the interface material can increase a contact surface between the cooler and the energy accumulator module. The interface material can have good heat-conducting properties. As a result, the interface material can form heat-conducting bridges within the unevennesses and can thereby reduce the heat transmission resistance.

Furthermore, the invention also comprises a method for producing an energy accumulator device, with the following steps:

providing a cooler with at least one cooling surface for absorbing or dissipating thermal energy;

providing a battery with at least one contact surface for the cooling surface of the cooler to rest on;

providing a device for pressing the cooler onto the battery, with a pressure part having at least one spring-elastic pressure element for transmitting a press-on force to a subregion of a surface of the cooler that faces away from the battery, and with a suspension unit for suspending the pressure part on the battery, wherein the suspension unit is designed in order to produce a suspension force directed counter to the press-on force when the cooler is arranged on the battery and the suspension unit is suspended on the battery;

arranging the cooler on the battery, wherein the cooling surface is arranged on the contact surface; and

suspending the suspension unit on the battery in order to transmit the press-on force to at least the subregion of that surface of the cooler that faces away from the battery.

Advantageous exemplary embodiments of the present invention are explained in more detail below with reference to the attached drawings, in which:

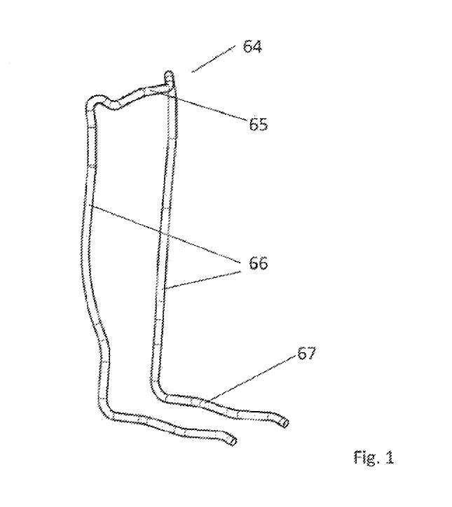

FIG. 1 shows a three-dimensional illustration of a basic design of a wire clamping strap;

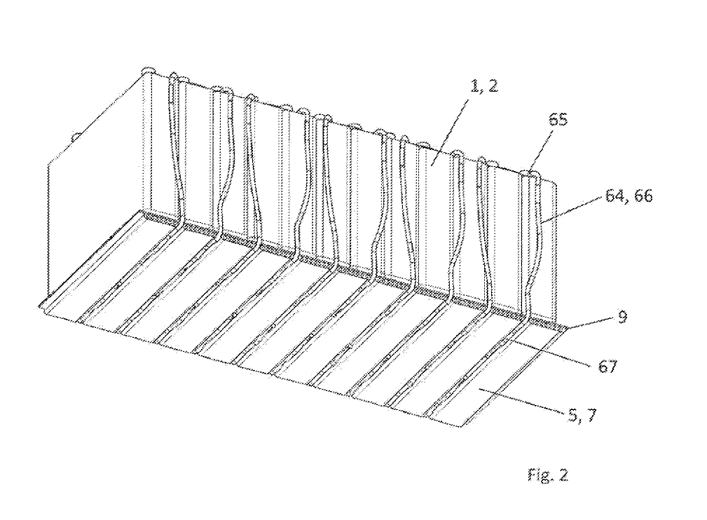

FIG. 2 shows a three-dimensional illustration of wire straps in the fitted assembly with cooler and cell stack;

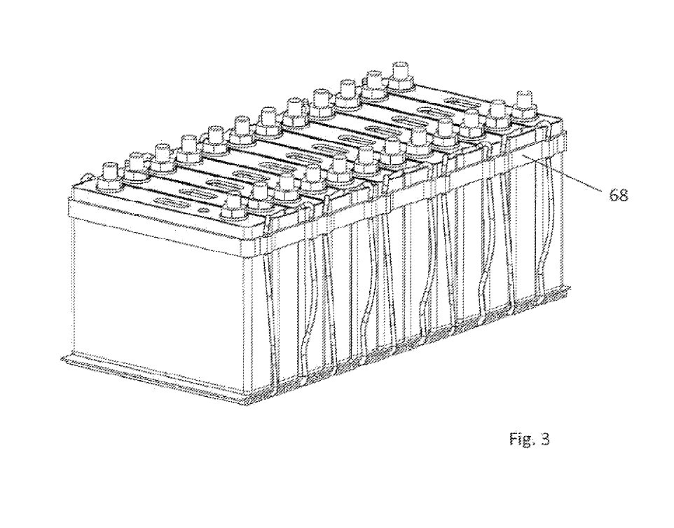

FIG. 3 shows a three-dimensional illustration of a cooler/cell stack/wire strap assembly with a clamping belt;

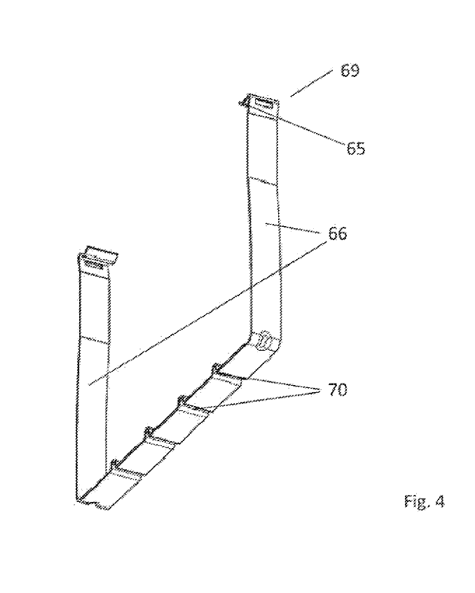

FIG. 4 shows a three-dimensional illustration of a basic design of a flat-belt clamping strap;

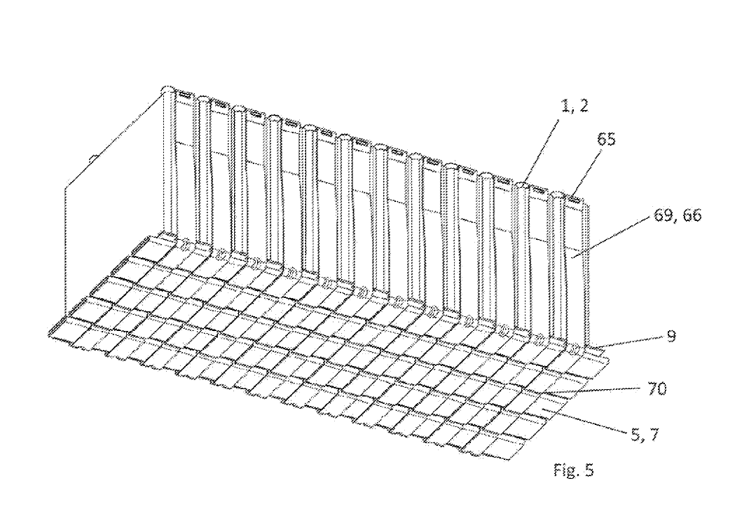

FIG. 5 shows a three-dimensional illustration of clamping straps in the fitted cooler/cell stack assembly;

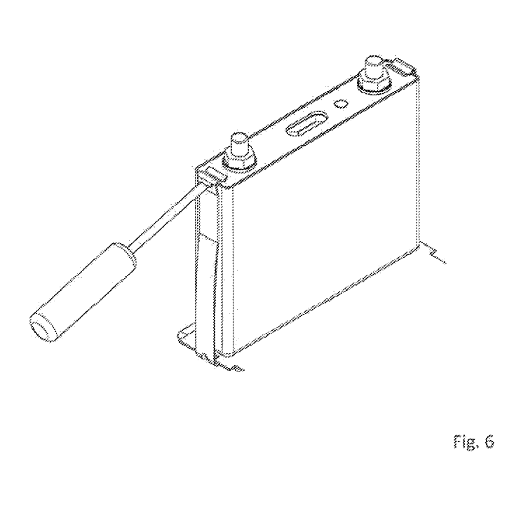

FIG. 6 shows a three-dimensional illustration of an installation of a clamping strap;

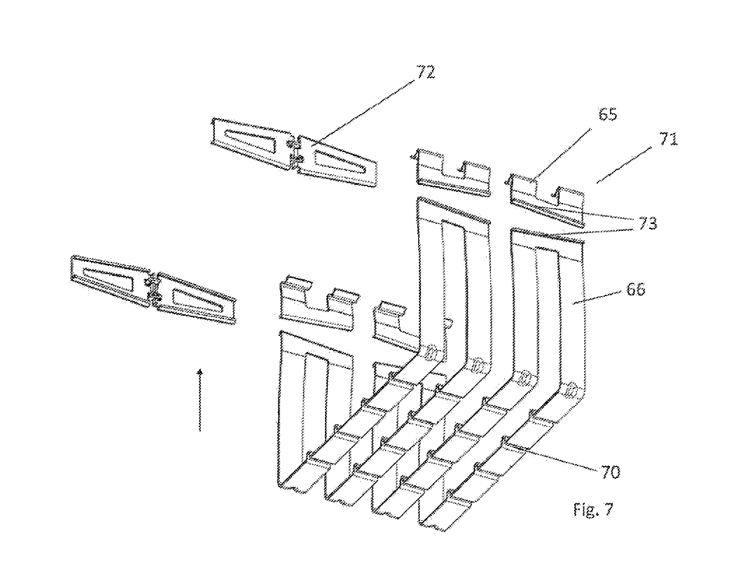

FIG. 7 shows a three-dimensional illustration of a basic design of two double clamping straps with turnbuckles;

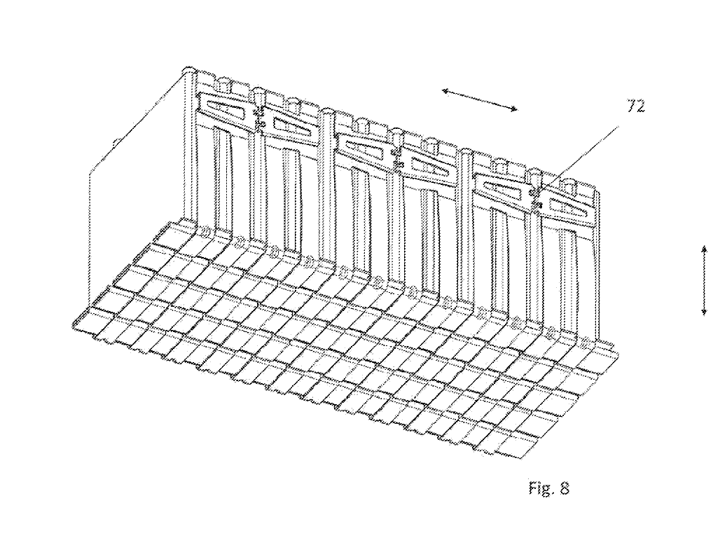

FIG. 8 shows a three-dimensional illustration of turnbuckles in the fitted state;

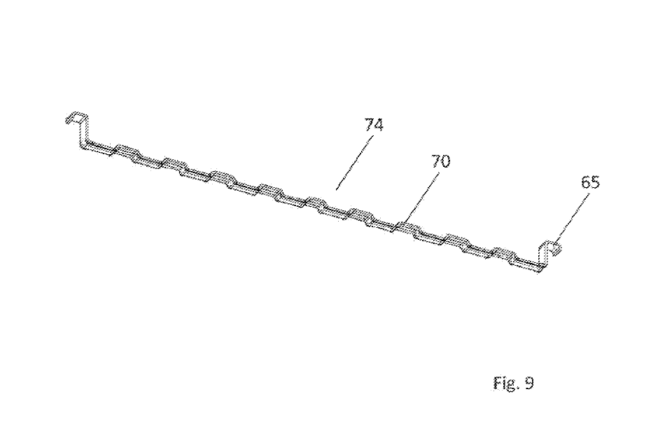

FIG. 9 shows a three-dimensional illustration of a clamping strap “longitudinally” embossed/curved in a tensioned state;

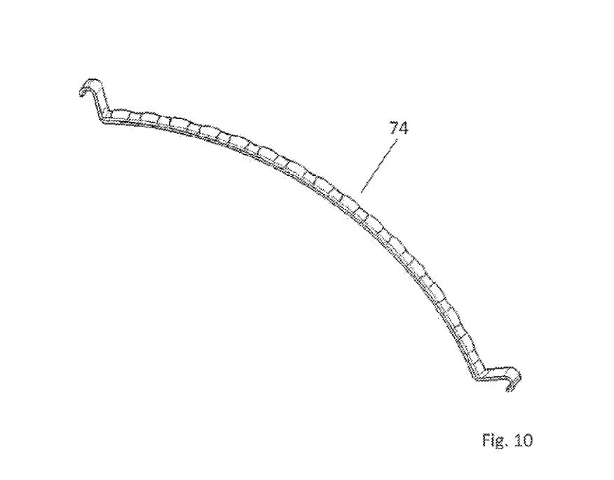

FIG. 10 shows a three-dimensional illustration of a clamping strap “longitudinally” embossed/curved in a precurved, relaxed state;

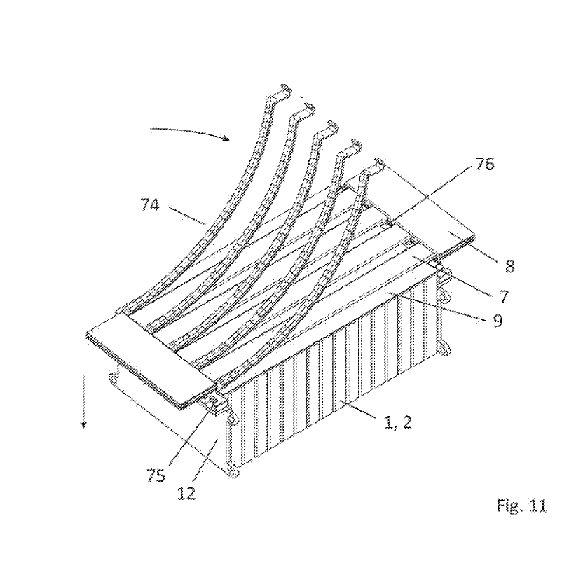

FIG. 11 shows a three-dimensional illustration of an installation of the precurved clamping strap “longitudinally”;

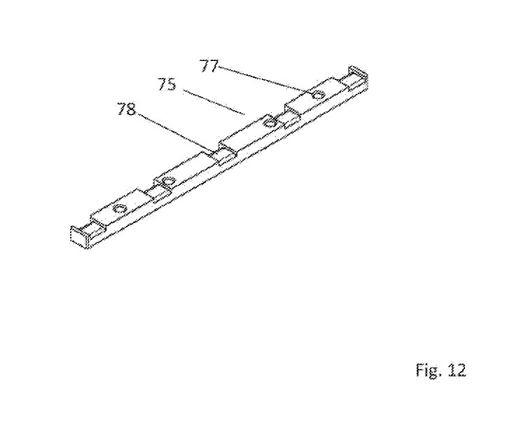

FIG. 12 shows a three-dimensional illustration of a bearing plate for clamping straps;

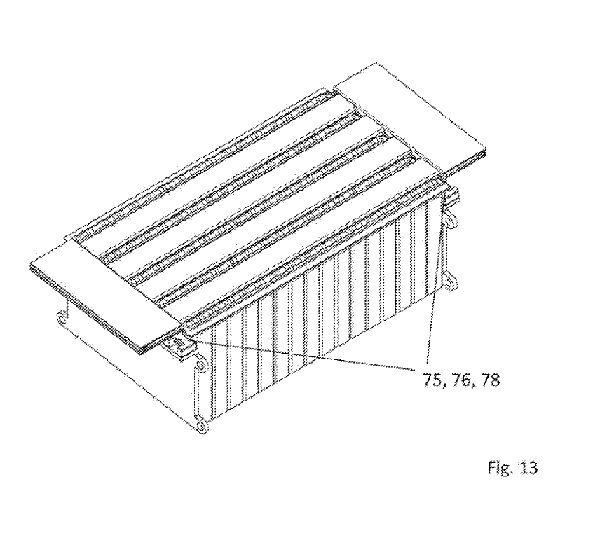

FIG. 13 shows a three-dimensional illustration of a cooler connected by clamping straps “longitudinally” to a cell stack;

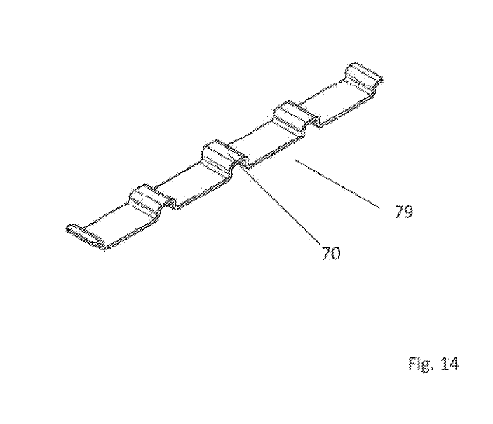

FIG. 14 shows a three-dimensional illustration of a clamping strap “transversely” as a loose part in a tensioned position;

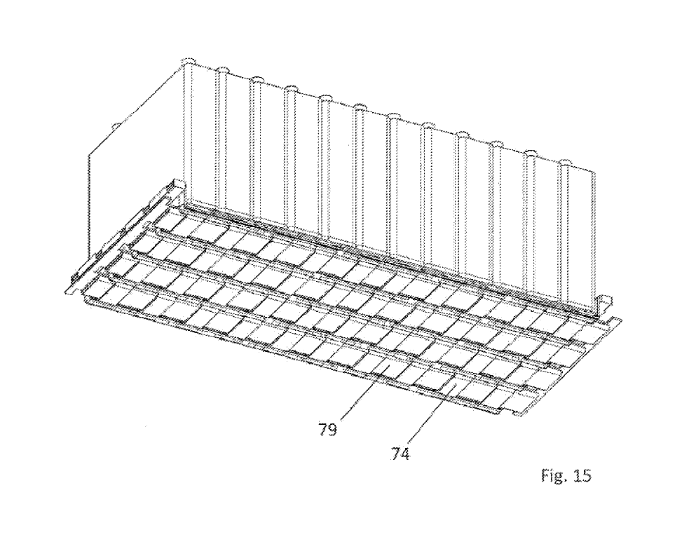

FIG. 15 shows a three-dimensional illustration of a cooler connected by clamping straps “longitudinally” and “transversely” to a cell stack;

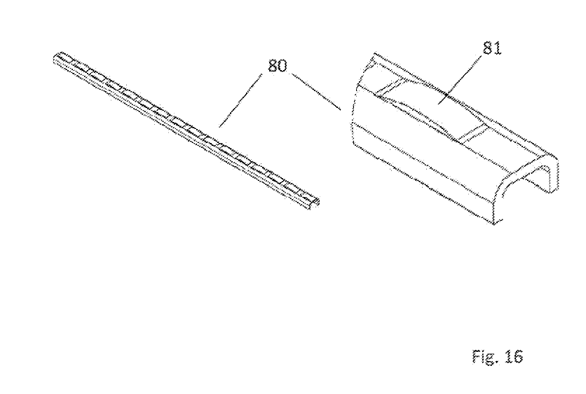

FIG. 16 shows a three-dimensional illustration and a view of a detail of a clamping strap in U form, tensioned;

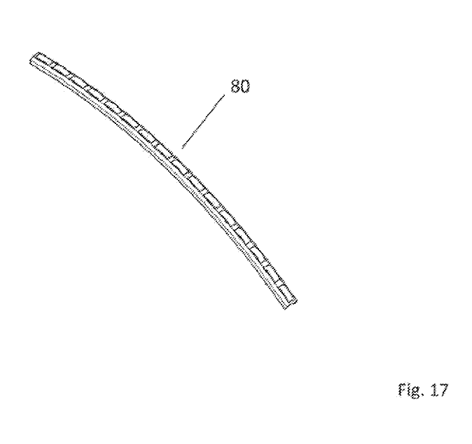

FIG. 17 shows a three-dimensional illustration of a clamping strap in U form, precurved/relaxed;

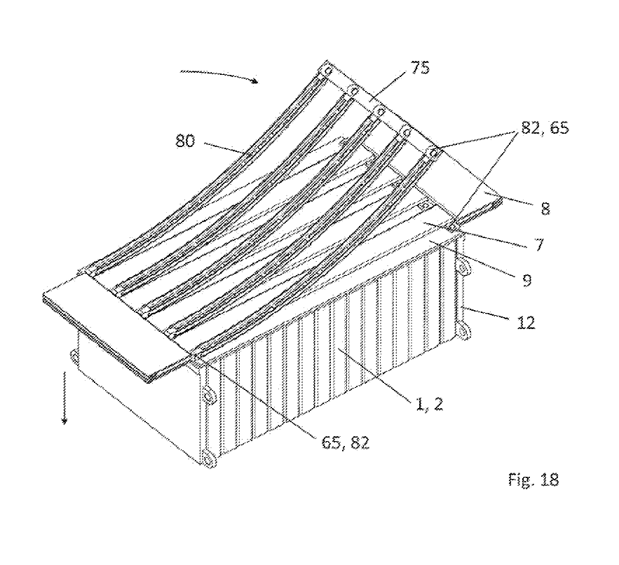

FIG. 18 shows a three-dimensional illustration of an installation of the precurved clamping strap;

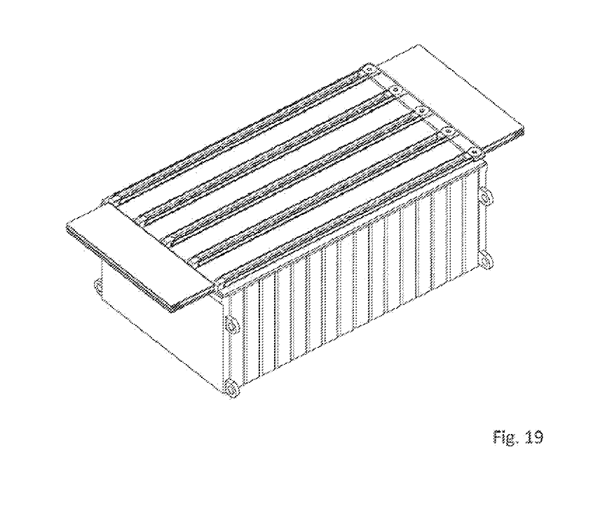

FIG. 19 shows a three-dimensional illustration of a cooler connected to a cell stack by clamping straps in U form;

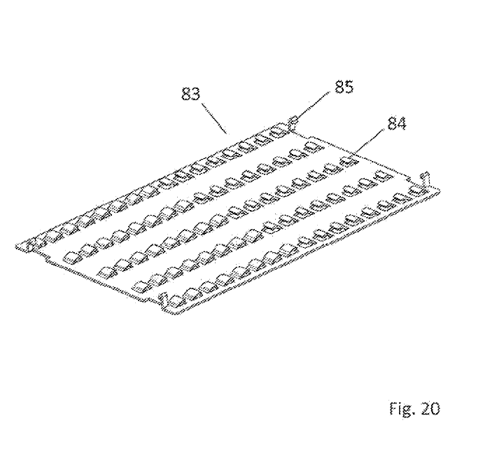

FIG. 20 shows a three-dimensional illustration of a spring plate “in a single part” with integrally formed pressure elements;

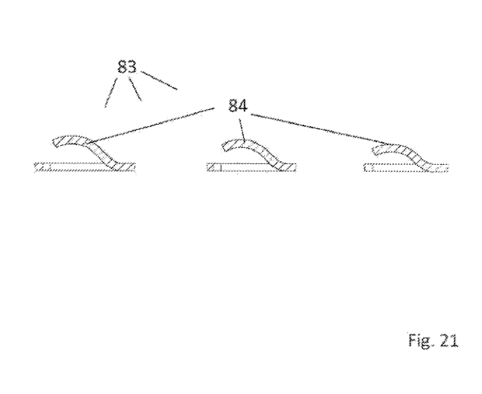

FIG. 21 shows cutouts from longitudinal sections through pressure elements in the form of “springs” of individual height;

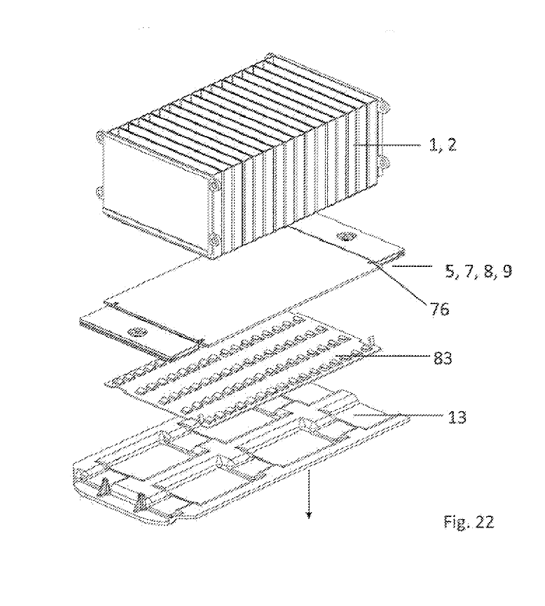

FIG. 22 shows a three-dimensional exploded illustration of the components;

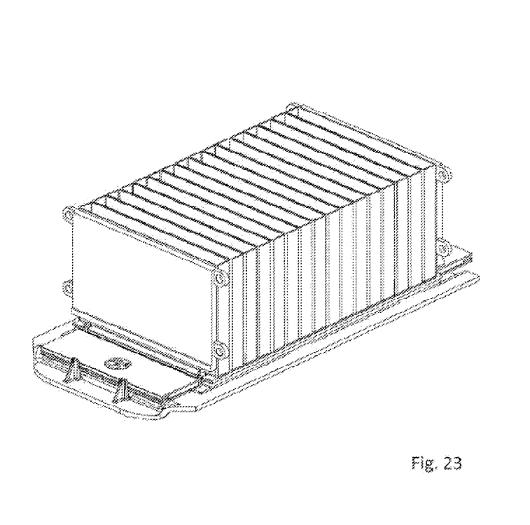

FIG. 23 shows a three-dimensional illustration of a bracing means which is effective after frictional connection of the components;

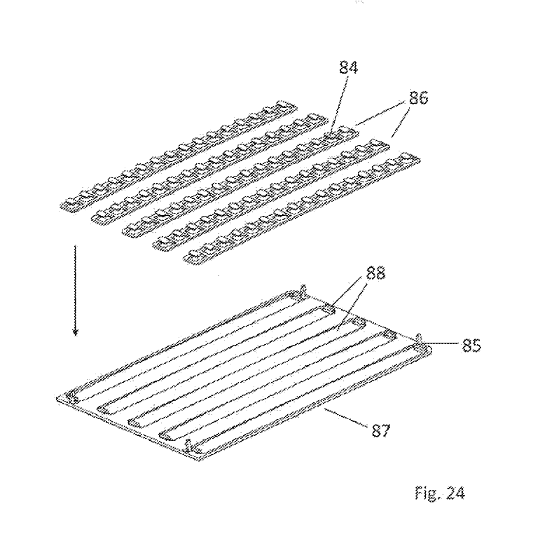

FIG. 24 shows a three-dimensional illustration of spring plates in “strip form” as identical parts with an adapter plate;

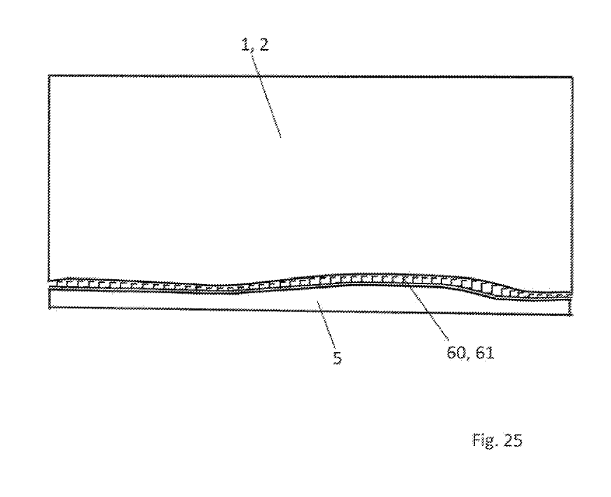

FIG. 25 shows a schematic two-dimensional illustration of the assembly of a battery with an adaptation plate or a gill plate;

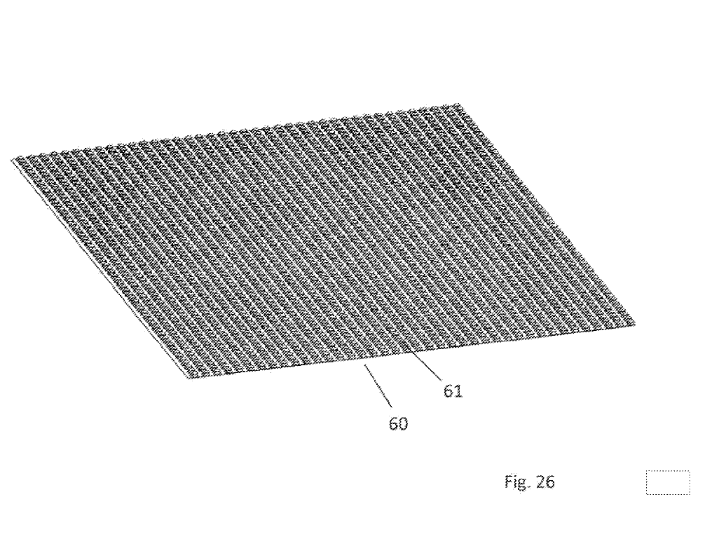

FIG. 26 shows a three-dimensional illustration of an adaptation plate or a gill plate;

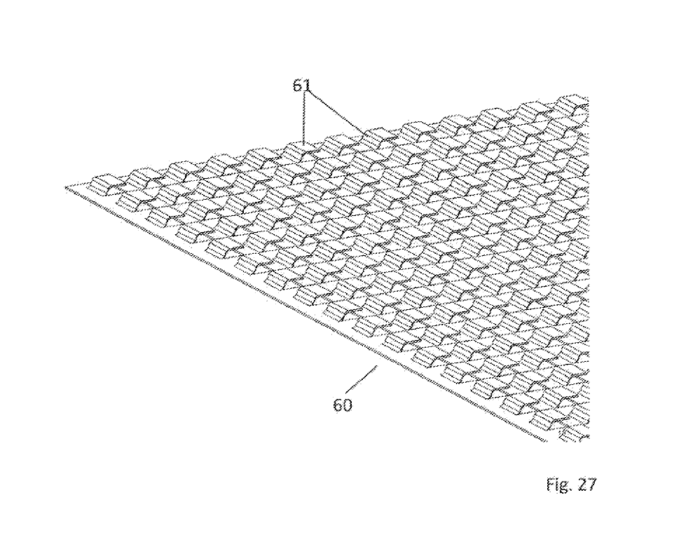

FIG. 27 shows a three-dimensional illustration of a cutout of an adaptation plate or a gill plate;

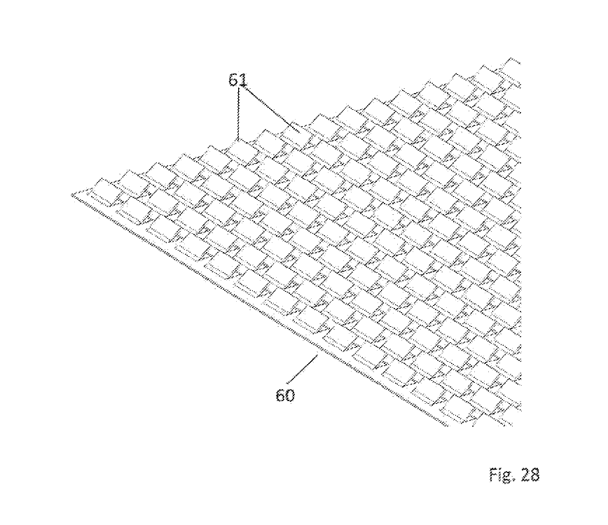

FIG. 28 shows a three-dimensional illustration of a cutout of an alternative adaptation plate or gill plate;

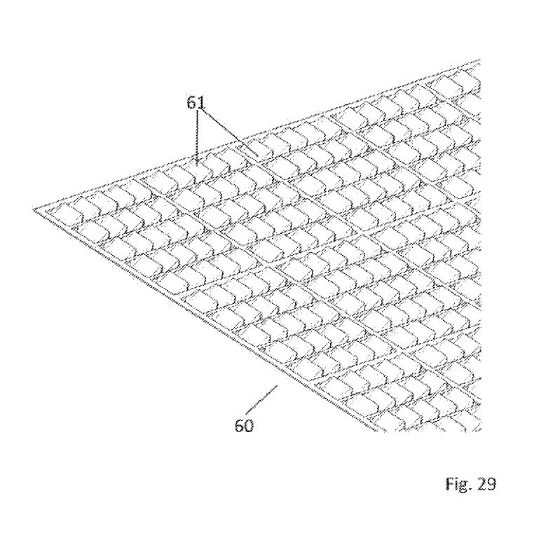

FIG. 29 shows a three-dimensional illustration of a cutout of an alternative adaptation plate or gill plate;

FIG. 30 shows a three-dimensional illustration of a cutout of an alternative adaptation plate or gill plate;

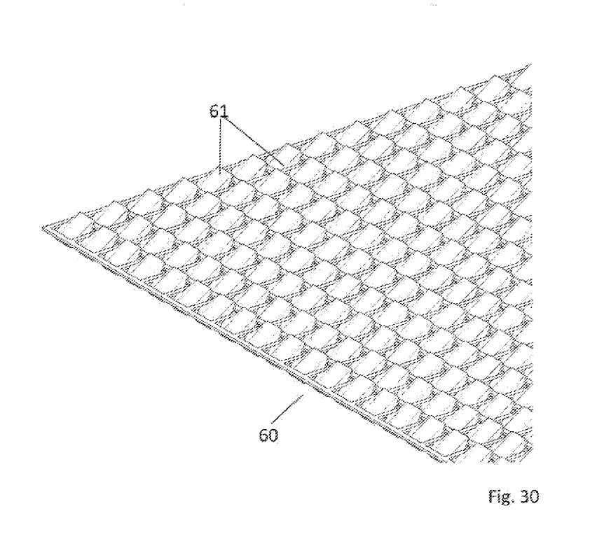

FIG. 31 shows a three-dimensional illustration of a cutout of an alternative adaptation plate or studded/embossed plate;

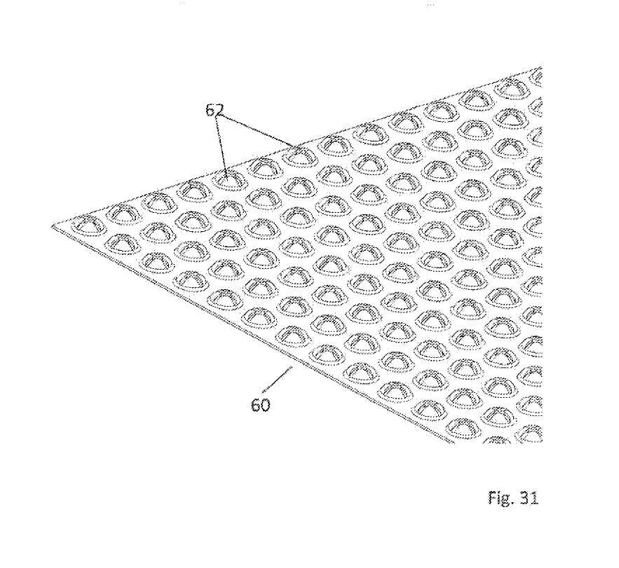

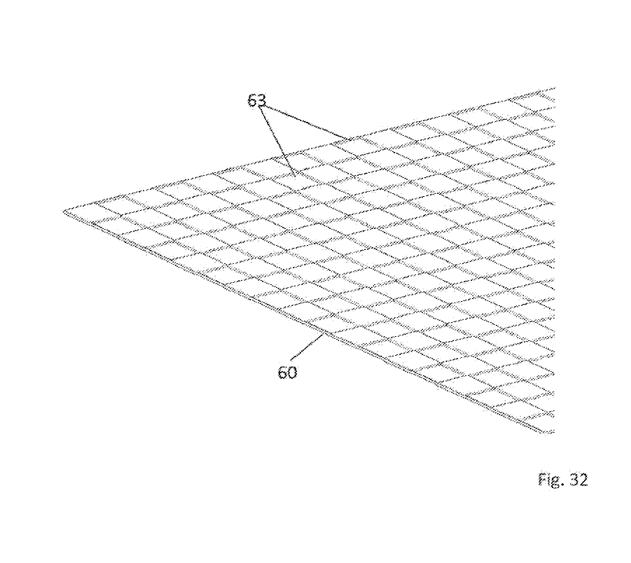

FIG. 32 shows a three-dimensional illustration of a cutout of an alternative adaptation plate or studded/embossed plate; and

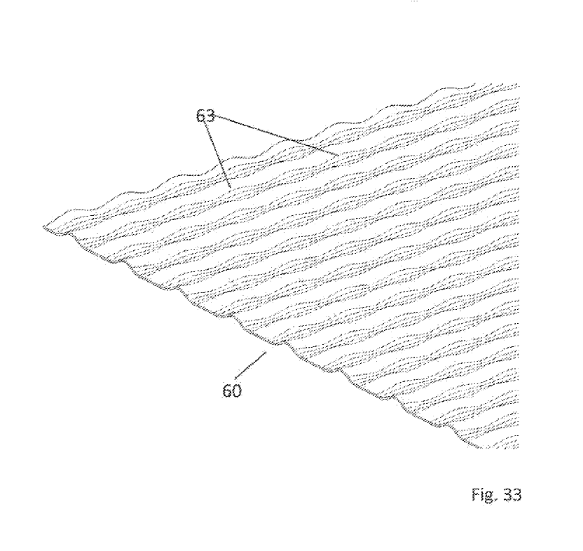

FIG. 33 shows a three-dimensional illustration of a cutout of an alternative adaptation plate or studded/embossed plate.

In the description below of the preferred exemplary embodiments of the present invention, identical or similar reference numbers are used for the similarly acting elements illustrated in the various drawings, with a repeated description of said elements being omitted. For a full listing of the reference numbers, a list of reference numbers is attached.

FIG. 1 shows a three-dimensional illustration of a basic design of a wire clamping strap, and FIG. 2 shows a three-dimensional illustration of wire straps in the fitted assembly with cooler and cell stack.

A bracing unit on the basis thereon consists of one or more three-dimensionally shaped wire straps 64 which can preferably be produced from spring steel. Each clamping strap can consist of a region with a structure 67 which is curved locally in a wavy manner and permits a specific pressure contact connection on the lower side of the cooling plate 5 at the high points of said clamping strap. For the function integration and for the geometrical stabilization, the wire strap 64 can consist of two symmetrically arranged limbs 66. In the vertically illustrated region of FIG. 1, the strap 64 has a curved structure 66 on both limbs, in order to permit an elastic longitudinal expansion during the installation operation. On the upper side, the wire strap 64 can be suspended 65 over a cell 2 or over a cell stack 1, 2 and can thereby form the counterbearing.

Optionally, the fitted bracing strap 64 can additionally be secured on the upper side 1 of the stack against release by means of a peripheral, elastic or by means of a plastically permanently deformed clamping belt 68. The bracing straps 64 can advantageously consist of identical parts which can be manufactured cost-effectively. Permanent bracing in the fitted state without relaxation is possible. No small-sized connecting elements are required. By means of an engagement in the clearance between the transversely arranged cooler flat tubes 7 on the lower side and the flat arrangement laterally and above the cell 2 or the cell stack 1, the clamping elements 64 take up little construction space. A uniform distribution of pressure can be achieved by specifically shaped and uniformly distributed high points of the “shafts” 67. Wire clamping straps 64 are preferably usable in the case of cooler flat tubes 7 arranged parallel to the straps 64 because of the engagement, which is approximately neutral in terms of construction space, between the longitudinal sides of said flat tubes 7.

FIG. 3 shows a three-dimensional illustration of a cooler/cell stack/wire strap assembly with a clamping belt, and FIG. 4 shows a three-dimensional illustration of a basic design of a flat-belt clamping strap. FIG. 5 shows a three-dimensional illustration of clamping straps in the fitted cooler/cell stack assembly. FIG. 6 shows a three-dimensional illustration of an installation of a clamping strap.

The bracing unit consists of one or more two- or three-dimensionally shaped straps 69 which can preferably be produced from flat-belt spring steel. Each clamping strap 69 can consist of a region having one or more bending-tab high points 70 produced by bending over, permitting a specific pressure contact connection on the lower side of the cooling plate 5. In the vertically illustrated region, the strap 69 has a curved structure 66 on both limbs, in order to permit an elastic longitudinal expansion during the installation operation. On the upper side, the clamping strap 69 can be suspended 65 over a cell 2 or over a cell stack 1 and can thereby form the counterbearing.

Optionally, the fitted flat-belt strap 69 can additionally be secured on the upper side 1 of the stack against release by means of a peripheral elastic or by means of a plastically permanently deformed clamping belt 68, cf. FIG. 3. The installation of a clamping strap 69 can be facilitated by the fact that the latter is levered by means of an auxiliary tool through a laterally arranged slot onto a lateral edge of the cell 2 or of the cell stack 1, as shown in FIG. 6. The bracing unit 69 can advantageously consist of identical parts which can be manufactured cost-effectively. Permanent bracing in the fitted state without relaxation is possible. No small-sized connecting elements are required. By engagement in the clearance between the longitudinally arranged cooler flat tubes 7 on the lower side and the flat arrangement laterally and above the cell 2 or the cell stack 1, the clamping element 69 take up little construction space. A uniform distribution of pressure can be achieved by specifically curved and uniformly distributed high points of the bending tabs 70. The level of the contact pressure can be varied by different heights of the bending tabs 70. Flat-belt clamping straps 69 are preferably usable in the case of cooler flat tubes 7 arranged orthogonally to the straps 69 because of the engagement, which is approximately neutral in terms of construction space, between the longitudinal sides of said flat tubes 7.

FIG. 7 shows a three-dimensional illustration of a basic design of two double clamping straps with turnbuckles. The arrow shows the Z direction. FIG. 8 shows a three-dimensional illustration of turnbuckles in a fitted state. The horizontal arrow in the illustration shows a latching direction.

The vertical arrow in the illustration shows a tensioning direction. The bracing unit consists of a plurality of three-dimensionally shaped straps 71 which can preferably be produced from spring steel, and a plurality of punched and bent parts 72 which can be produced from metal materials or, as injection molded parts, also from plastic. Each double clamping strap 71 can consist of a region having one or more high points 70 which are produced by bending over, permitting a specific pressure contact connection on the lower side of the cooling plate 5. In the vertically illustrated region, cf. FIG. 7, the strap 71 has a curved structure 66 on all of the limbs, in order to permit an elastic longitudinal expansion during the installation operation. On both sides, the double clamping strap 71 has an interruption 73 at which tabs 73 at a shallow angle of approx. 5-10° to the horizontal are bent over by more than 90° to the horizontal (FIG. 62). By a turn buckle counterpart 72, which is likewise bent over twice by more than 90° in a wedge-shaped manner, being slipped on laterally, the interrupted region 73 is connected again and the distance during the advancing movement in the—here—Z direction is reduced in such a manner that, after the straps 71 have engaged around the cell 2 or cell stack 1, on the one hand, and the cooler 5, on the other hand, a tensioning force forms in said—here—Z direction. A turn buckle 72 can be designed in the form of an identical part in such a manner that, rotated through 180°, it can be connected again to a second identical component 72 and, by suitable provision of latching hooks and latching apertures, form a type of “lock” such that automatic release of the bracing means is permanently prevented in a form-fitting manner. Optionally, the fitted bracing unit 71, 72 can be additionally secured on the upper side 1 of the stack against release by means of a peripheral elastic or by means of a plastically permanently deformed clamping belt 68, cf. FIG. 3. The bracing unit 71, can advantageously consist of few identical parts which can be manufactured cost-effectively. During the installation of the turn buckle 72, a greater tensioning force can be obtained in the direction of action and therefore an increased contact pressure can be built up at the thermal transition between cell 2 or cell stack 1 and cooler cover plate 9. Double flat-belt clamping straps 71 are preferably usable in the case of cooler flat tubes 7 arranged orthogonally to the straps 71 because of the engagement, which is approximately neutral in terms of construction space, between the longitudinal sides of said flat tubes 7.

FIG. 9 shows a three-dimensional illustration of a clamping strap “longitudinally” embossed/curved in a tensioned state. FIG. 10 shows a three-dimensional illustration of a clamping strap “longitudinally” embossed/curved in a precurved, relaxed state. FIG. 11 shows a three-dimensional illustration of an installation of the precurved clamping strap “longitudinally”. The curved arrow shows an installation direction. The vertical arrow in the illustration shows the Z direction. FIG. 12 shows a three-dimensional illustration of a bearing plate for clamping straps. FIG. 13 shows a three-dimensional illustration of a cooler connected to a cell stack by clamping straps “longitudinally”. The bracing unit consists of one or more two- or three-dimensionally shaped straps 74 which can be manufactured in an embossed and/or curved manner and can preferably be produced from spring steel, two bearing plates 75 which can be produced from diverse materials by a very wide variety of manufacturing processes, and of just a few connecting elements, for example screws. The bearing plates 75 can be joined to the module carrier 12, also to a pressure plate. Each clamping strap 74 can consist of a region with one or more bending-tab high points 70 produced by bending over, permitting a specific pressure contact connection on the lower side of the cooling plate 5. The clamping strap 74 is illustrated in a tensioned state in FIG. 9. In the relaxed state, see FIG. 10, the strap can have a defined shape precurved convexly in side view. The aim of clamping a cooler 5 to a cell stack 1 uniformly with as high and as defined a pressure as possible is achieved with said bracing unit 74 by the fact that one side of one or more precurved clamping straps 74 is first of all fitted on one side of the cell stack 1, for example the front or rear side, between the longitudinally arranged flat tube 7, which is made possible, for example, by the form-fitting suspension of integrally formed hooks 65, before the clamping strap 74 is curved back into the flat state by elastic deformation. By means of a plurality of embossed or curved high points 70 preshaped in a defined manner along the strap 74, a regular and uniform distribution of pressure onto the cooler 5 can be brought about.

The bracing unit can optionally be supplemented by clamping straps 74, 75 in the transverse direction. The clamping straps 74 “transversely” can likewise be precurved convexly. In this case, the clamping straps 74 “longitudinally” can be arranged neutrally in terms of construction space between the flat tubes 7. In this case, the clamping straps 74 “transversely” have to be conducted around the flat tubes 7 and therefore increase the overall height at least by the flat-belt wall thickness 74 (FIG. 70). The clamping strap 74, 79 “transversely” can either be placed as loose parts 79 transversely in the recessed regions of the clamping straps 74 “longitudinally” or else can be connected to the latter in an integrally bonded manner, by means of welding or adhesive bonding, or frictionally by means of a mechanical joining method, such as, for example, clinching. When clamping straps 74 are used in the longitudinal direction and in the transverse direction, the number of components required can also be varied, and therefore in the longitudinal direction, for example, a clamping strap 74 “longitudinally” does not absolutely have to be arranged in each clearance between the flat tubes 7, but rather a uniform distribution of the pressure forces can increasingly be undertaken by additionally fitted clamping straps 74 “transversely”. The bracing unit 74, 79 can advantageously consist of a few identical parts which can be manufactured cost-effectively and permits permanent bracing in the fitted state without relaxation. Only a few connecting elements are required. By means of engagement in the clearance between the longitudinally arranged cooler flat tubes 5 on the lower side, the clamping elements take up little construction space and do not take up any construction space on the transverse sides and above the cell stack 1. A uniform distribution of pressure can be achieved by high points 70, which are curved in a specific manner and are distributed uniformly, on the clamping elements. The level of the contact pressure can be varied by different heights of the bending tabs 70. The transverse distribution of the pressure points can be undertaken by additionally using clamping straps 79 “transversely”, thus making it possible to reduce the number of clamping straps 74 “longitudinally”. The bracing unit can be premanufactured as a three-dimensionally curved “clamping net” 74, 79. Flat-belt clamping straps 74 “longitudinally” are preferably usable in the case of cooler flat tubes 7 arranged orthogonally to the strap 74. Flat-belt clamping straps 79 “transversely” can additionally be used for the transverse distribution of pressure. Said flat-belt clamping straps 79 then engage around the cooler flat tubes 7 on the lower side thereof. FIG. 14 shows a three-dimensional illustration of a clamping strap “transversely” as a loose part in a tensioned position. FIG. 15 shows a three-dimensional illustration of a cooler connected to a cell stack by clamping straps “longitudinally” and “transversely”.

FIG. 16 shows a three-dimensional illustration and a view of a detail of a clamping strap in U form, tensioned. FIG. 17 shows a three-dimensional illustration of a clamping strap in U form, precurved and relaxed. FIG. 18 shows a three-dimensional illustration of an installation of the precurved tensioning straps. The curved arrow in FIG. 18 shows a installation direction. The vertical arrow in the illustration shows the Z direction. FIG. 19 shows a three-dimensional illustration of a cooler connected to a cell stack by clamping straps in U form.

The bracing unit consists of one or more two- or three-dimensionally shaped straps 80 which can be manufactured in a manner cut to size in the form of punched and bent parts and can preferably be produced from spring steel. The basic profile here can likewise be rolled in a U cross-sectional form, then shortened to any length and, in a punching and embossing process, precurved with a defined shape and provided with defined pressure points 81. Also required is a bearing plate 75, with the aid of which the clamping straps 80 can be jointly fastened and which can be produced by a wide variety of manufacturing methods from diverse materials and from just a few connecting elements, for example screws. Each clamping strap 80 can consist of a region with one or more pressure points 81 which permit a specific pressure contact connection on the lower side of the cooling plate 5. The clamping strap 80 is illustrated in a tensioned state in FIG. 16. In the relaxed state, FIG. 17, the strap 80 can have a defined shape precurved convexly in side view. The clamping straps 80 are pressed against the cooler 5 via the bearing plates 75, which are connected 82, 65 to the pressure plates on both sides. The bracing unit 80 can advantageously consist of few identical parts which can be manufactured cost-effectively. The clamping straps 80 in the basic form thereof here can be manufactured simply by cutting to size from “cut goods”. A permanent bracing in the fitted state without relaxation is possible. Only a few connecting elements are required. By engagement in the clearance between the longitudinally arranged cooler flat tubes 7 on the lower side, the clamping elements take up little construction space and take up no construction space on the transverse sides and above the cell stack 1. A uniform distribution of pressure can be achieved by high points, which are curved in a specific manner and are distributed uniformly, on the clamping elements. Flat-belt clamping straps of “U shape” 80 are preferably usable in the case of cooler flat tubes 7 arranged parallel to the straps 80. Bearing points 78, 65 for the clamping straps and screw-on points 82 can ideally be integrated into the pressure plates or fastening plates 12 of the cell stack 1 on the end sides thereof, in order to reduce the number of required components.

FIG. 20 shows a three-dimensional illustration of a spring plate “in single-part form” with integrally formed pressure elements. FIG. 21 shows cutouts from longitudinal sections through pressure elements, springs, of individual height. FIG. 22 shows a three-dimensional exploded illustration of the components. FIG. 23 shows a three-dimensional illustration of a bracing means which is effective after frictional connection of the components. The arrow shows the direction of the frictional connection of a cell stack with a counterbearing, here the housing part, and the components cooler and spring plate—located in between. FIG. 24 shows a three-dimensional illustration of spring plates in “strip form” identical parts with an adapter plate.

The bracing unit 83 can consist of just one or else more components which can be produced from spring steel in a punching and bending process. One such component is called a spring plate 83 here and can be connected to the cooler 5 in a form-fitting manner, for example by integrally formed hooks 85, or else placed in a form-fitting manner into a suitable housing part 13. Tabs 84 can be raised from at least one plane of the spring plate 83 and individually shaped in such a manner that said tabs take on the function of pressure elements 84 that are resilient in a defined manner. The pressure elements 84 can be arranged in rows in such a manner that the flat tubes 7 of the cooler 5 can come to lie between said elements 84 in a space-saving manner. The cooler 5 is braced to the cell 2 or cell stack 1 by the spring plate 83 being fitted on one side of the cooler 5, which side is opposite the cell 2 or the cell stack 1, and the cell 2 or cell stack 1 being connected to a suitable dimensionally stable counterbearing, such as, for example, a housing part 13 or a module carrier 12 in a frictional manner, for example by screwing (FIG. 22). The pressure elements 84 can be individually formed, and therefore, for example, a locally smaller press-on force, caused by sag in the cell stack 1 or in a housing part 13 because of pressure elements 84 having greater penetration and/or a higher spring constant, can be compensated for.

Alternatively, the pressure elements 84 of a spring plate 83 can also be manufactured in the form of “strips” 86 of identical construction which can be cut to size. In this case, the compensation of sag can be taken on by an adapter component 87 which receives said spring elements, as illustrated in FIG. 24. Depending on the rigidity of the cell stack 1 and/or counterbearings, the adapter plate 87 can obtain local elevations/curvatures and, for example on the lower side, can obtain individual elements for the shaped receptacle 88. The bracing unit 83, 86, 88 can advantageously consist of very few components. A permanent bracing in the fitted state without relaxation is possible. Only a few connecting elements, for example screws, are required. As a result, the clamping elements take up little construction space, and also take up no construction space on the transverse sides and above the cell stack 1. A uniform distribution of pressure can be achieved by pressure elements which are curved and arranged in a defined manner. Possible sag in the cell stack 1 and/or counterbearings, for example in the housing components 13, can additionally be compensated for by individually shaped pressure elements, springs 84. Resilient elements 83, 84, 86 for the permanent bracing without relaxation can also be realized very cost-effectively and with little tool complexity as identical parts or cut goods which can be cut to length individually. In order to receive identical-part spring elements 83, 86 and for the adaptation 88 to individual counterbearings—for example housing components 13 or module carrier 12—an element which is preferably produced by a casting method can be used. Spring plates 83, 86 are usable in the case of cooler flat tubes 7 running longitudinally or transversely. In order for the bracing to be effective, cell 2 or cell stack 1 has to be connected to the counterbearing in a frictional manner, for example by screwing.

FIG. 25 shows a schematic two-dimensional illustration of the assembly of a battery with an adaptation plate or gill plate. In addition to the exemplary embodiments explained, it may be necessary to introduce intermediate materials, what are referred as interface materials, between cooler and battery or cell or stack, in order further to improve the thermal contact. This can be necessary in particular whenever the unevennesses and roughnesses of the parts to be joined are very pronounced and/or the cooler or the battery is of such rigid design that an adequate adaptation of the cooler to be interface surface of the battery by means of contact pressure of a bracing device does not bring about contact regions of a satisfactory size. The interface material therefore enlarges the effectively heat-conducting contact surface or reduces the trapping of air, which is effective in an opposed manner, between cooler and battery.

FIG. 26 shows a three-dimensional illustration of an adaptation plate or a gill plate. FIG. 27 shows a three-dimensional illustration of a cutout of an adaptation plate or a gill plate. FIG. 28 shows a three-dimensional illustration of a cutout of an alternative adaptation plate or gill plate. FIG. 29 shows a three-dimensional illustration of a cutout of an alternative adaptation plate or gill plate. FIG. 30 shows a three-dimensional illustration of a cutout of an alternative adaptation plate or gill plate. FIG. 31 shows a three-dimensional illustration of a cutout of an alternative adaptation plate or studded/embossed plate. FIG. 32 shows a three-dimensional illustration of a cutout of an alternative adaptation plate or studded/embossed plate, and FIG. 33 shows a three-dimensional illustration of a cutout of an alternative adaptation plate or studded/embossed plate.

The interface materials shown here can be of a very wide variety of types and basically are divided into the three groups—structural plates 60, adapting intermediate media and integrally bonded connections. Structural plates 60 can be soldered to the cooler. Structural plates 60 in the form of an adaptation plate or gill plate 60 are adapted to the two contact surfaces when cooler and battery are pressed together. For this purpose, the structural plate 60 can be designed in the form of an adaptation plate or studded/embossed plate 60, in the form of a preshaped, arched shaped plate, or in the form of a microstructured plate. Similarly, structural plates 60 can be designed in the form of sheet-metal sections or points having different rigidities, in the form of a corrugated embossed plate, in the form of a corrugated rib plate or corrugated ribs, or in the form of a slotted aluminum foil. In this case, a slotted foil is stretched and thereby obtains a 3D surface. Furthermore, the structural plate 60 can be designed in the form of a sandwich honeycomb plate, in the form of a needle-punched plate, in the form of a pull-off film with intermediate studs made of elastomer, or in the form of an aluminum foil.

In a complementary manner with respect thereto, use can be made of adapting intermediate media, such as heat-conducting film, heat-conducting silicone casting compound, kneading compound—curing, adhesive compound, aluminum powder, ceramic paste, copper paste, liquid metal, amorphous aluminum wool, PTC adhesive, phase change material, metal nonwoven, metal fleece, metal touch and close tapes, metal wool, metal flakes, compressible graphite films, PUR foam in cans; expanding graphite foam, liquid/sprayable rubber; or sprayable wax. For connecting the structural plates shown to at least one of the contact surfaces, use can also be made of integrally bonded connections, such as, for example, “baking on”, sintering also with intermediate sintering material, vibration welding, microsoldering, friction welding or exothermal foil welding, for example with NiAl nano-active foils. Adhesive compounds for welding can also permit a direct contact connection of the cell to cooling agents.

The exemplary embodiments described are selected merely by way of example and can be combined with one another.

### LIST OF REFERENCE NUMBERS

1 Battery and/or battery stack
2 Battery cell
5 Cooler and/or heater
6 Laminated plate design of the cooler
7 Extrusion profiles, for example flat tubes of the cooler
8 Collecting tank of the cooler
9 Cover plate or reinforcing plate of the cooler
12 Battery or battery stack holder/carrier, also module carrier
13 Battery housing
60 Structural plate, in particular adaptation plate, gill plate or studded/embossed plate
61 Gills or fins
62 Slotted studs or embossing
63 Embossing
64 Bracing strap
65 Suspension region of the bracing strap
66 Curved structure of the bracing strap in the limb region
67 Wavy structure of the bracing strap
68 Clamping belt of the bracing strap
69 Flat-belt bracing strap
70 Bending tabs of the flat-belt bracing strap
71 Double clamping strap
72 Turn buckle made from flat-belt spring steel
73 Turn buckle engagement
74 Curved clamping strap embossed longitudinally
75 Bearing plates
76 Aperture for suspension region of clamping strap hook
77 Internally threaded bearing plate for screwing to the pressure plates
78 Bearing points of the bearing plate for the suspension of the clamping straps
79 Clamping strap “transversely” in the form of a loose part
80 Clamping strap longitudinally with U-shaped cross section—cuttable to size
81 Bearing point
82 Connection of clamping strap to pressure plate, for example screw-on point
83 Spring plate
84 Pressure element—spring
85 Latching hook
86 Spring plate strips
87 Adapter plate
88 Receptacle or fastening of the spring plate strips

1. A device for pressing a cooler against a battery, wherein the cooler has at least one cooling surface for absorbing or dissipating thermal energy, and wherein the battery has at least one contact surface for the cooling surface of the cooler to rest on, wherein the device has the following features:
a pressure part with at least one spring-elastic pressure element for transmitting a press-on force to a subregion of a surface of the cooler that faces away from the battery; and
a suspension unit for suspending the pressure part on the battery, wherein the suspension unit is designed in order to produce a suspension force directed counter to the press-on force when the cooler is arranged on the battery and the suspension unit is suspended on the battery.

2. The device as claimed in claim 1, in which the suspension unit has at least one elastically stretchable section in order to produce the suspension force when the section is stretched.

3. The device as claimed in claim 1, in which the pressure part has a plurality of spring-elastic pressure elements which have different heights in order to distribute the press-on force uniformly to a plurality of subregions of the cooler.

4. The device as claimed in claim 1, in which the pressure part has a spring-elastic basic body which has a precurvature when the suspension unit is not suspended.

5. The device as claimed in claim 1, with a plurality of pressure parts which are at least connected to one spacer and are arranged next to one another.

6. The device as claimed in claim 1, in which the suspension unit is designed in order to be suspended on a surface of the battery that is opposite the contact surface of the battery.

7. The device as claimed in claim 1, in which the suspension unit is designed in order to be suspended on a suspension unit arranged in the region of the contact surface of the battery.

8. An energy accumulator device with the following features:
a cooler with at least one cooling surface for absorbing or dissipating thermal energy;
a battery with at least one contact surface for the cooling surface of the cooler to rest on, wherein the cooler is arranged on the battery; and
a device for pressing a cooler onto a battery as claimed in claim 1, wherein the suspension unit is suspended on the battery and produces the suspension force, which is directed counter to the press-on force, and the pressure part transmits the press-on force to a subregion of a surface of the cooler that faces away from the battery, with the at least one pressure part.

9. The energy accumulator device as claimed in claim 8, in which an intermediate material is arranged between the cooler and the battery.

10. A method for producing an energy accumulator device, with the following steps:
providing a cooler with at least one cooling surface for absorbing or dissipating thermal energy;
providing a battery with at least one contact surface for the cooling surface of the cooler to rest on;
providing a device for pressing the cooler onto the battery, with a pressure part having at least one spring-elastic pressure element for transmitting a press-on force to a subregion of a surface of the cooler that faces away from the battery, and with a suspension unit for suspending the pressure part on the battery, wherein the suspension unit is designed in order to produce a suspension force directed counter to the press-on force when the cooler is arranged on the battery and the suspension unit is suspended on the battery;
arranging the cooler on the battery, wherein the cooling surface is arranged on the contact surface; and
suspending the suspension unit on the battery in order to transmit the press-on force to at least the subregion of that surface of the cooler that faces away from the battery.
